(19) United States
(12) Patent Application Publication
(10) Pub. No.: US 2026/0228291 A1
(43) Pub. Date: Aug. 6, 2026

(54) Anti-Harm From AI

(71) Applicant: Mark E. Ogram, Tucson, AZ (US)

(72) Inventor: Mark E. Ogram, Tucson, AZ (US)

(21) Appl. No.: 18/831,974

(22) Filed: Dec. 16, 2025

Related U.S. Application Data
(63) Continuation-in-part of application No. 18/831,650, filed on Jun. 27, 2025.
Application No. 18/831,650 is a continuation-in-part of application No. 18/831,542, filed on Apr. 11, 2025, now abandoned.
Application No. 18/831,542 is a continuation of application No. 18/831,505, filed on Mar. 5, 2025.
Application No. 18/831,505 is a continuation-in-part of application No. 18/831,476, filed on Feb. 6, 2025, now Pat. No. 12,475,017.

(51) Int. Cl. G06F 21/10; G06F 16/953; G06F 16/955; G06Q 50/18

(52) U.S. Cl. CPC G06F 16/9535; G06F 16/951; G06F 16/953; G06F 16/9566; G06F 21/106; G06Q 50/18

(57) ABSTRACT

The invention creates a monitoring computer and system which receives a query from a user, rates the query relative to a danger level, and selectively communicates the query to a search computer drawn from a queue of search computers containing search software. The response from the search computer is evaluated for its danger level and, if appropriate, the query and the response are reported to a remote computer where is it is evaluated by either a supervisor individual (such as a parent or guardian) or an expert (such as a psychologist, social worker, physician, etc.). If the software is unsuitable, the software is removed from the queue and is posted/reported to a publicly available database for the public.

### PRIORITY

This is a continuation-in-part of U.S. patent application Ser. No. 18/831,650 , filed on Jun. 27, 2025, and entitled “Human Evaluation of AI”, which was a continuation-in-part of U.S. patent application Ser. No. 18/831,542 , filed on Apr. 11, 2025, and entitled “AI Maintenance”, which was a continuation of U.S. patent application Ser. No. 18/831,505 , filed on Mar. 5, 2025 and entitled Proprietary Data Protection Using AI”, which was a continuation-in-part of U.S. patent application Ser. No. 18/831,476 filed on Feb. 6, 2025, and entitled “Artificial Intelligence Validation”.

### BACKGROUND OF THE INVENTION

Since the introduction of AI search software, there has been an ever growing reports of the AI software encouraging suicide, dangerous behavior (finding medicines and weapons), sexual problems, as well as other cases. AI seems to be totally devoid of any programming relating t Asimov's first rule for robotics. This epidemic does not appear to be diminishing and is prevalent in young adults as well as toys for children. Within an industrial setting, this problem is even more acute with employees being tempted to breach the trust of their employer or eve blackmailed by the AI software itself.

Parents and supervisors are powerless to choose the AI software which is not demonstrating this type of behavior.

In a very broad sense, Artificial Intelligence (AI) is an intelligence exhibited, particularly for computer systems. The objective is to enable computers, via their software, to perceive their environment and to learn from that environment.

Unlike traditional search engines, AI software is able to synthesize various data sites into one coherent body. AI is often encountered in web search engines, recommendation systems, virtual assistants, autonomous vehicles, generative/creative tools and advanced reasoning for games.

A key to AI is that the AI program must be “taught” and that is where the “achilles heel” is encountered. As with humans, the environment and substance of the “teaching” defines what the intelligence is. Often, the source of the AI training is through existing data bases which already have been corrupted with dated and false data/information.

Another factor limiting AI is that the software “learns” from its experience. Even though two AI programs were taught from the same database, subsequent experiences affect this learning so that after a relatively short time, the two AI programs respond differently to the same query.

The user of the AI is totally unaware of these limitations and just assumes that all AI programs are equal. This isn't the case.

It is clear there is a need for evaluating artificial intelligence systems.

### SUMMARY OF THE INVENTION

In order to reduce physical, mental, and industrial damage, this invention creates a monitoring computer which receives a query from a user, rates the query relative to a danger level and selectively communicates the query to a search computer drawn from a queue of search computers containing search software (often AI assisted search software). The response from the search computer is evaluated for its danger level, and, if appropriate, the query and the response are reported to a remote computer where is it is evaluated by either a supervisor individual (such as a parent or plant foreman) or an expert (such as a psychologist). If a threshold of danger has been surpassed, the search computer is reported to a publicly available database where other users can make their own judgment on whether to use that particular search software or AI.

The present invention creates a system of computers having a central computer with a database of at least two queries. A remote “proctor” computer repetitively withdraws these queries and presents them to a remote AI operating computer to obtain an AI response to the queries. These AI responses are sent by the “Proctor” computer to several “polling” computers which uses their human operators to gauge the accuracy of the AI responses. The human evaluations are returned to the central computer for evaluation/compilation as to the accuracy of the AI computer.

Other embodiments of the invention apply to the situation where AI is being used to control a machine or plant. The AI software has two basic sections. The first section is dedicated to operating the machine or plant while a second section is substantially off-line while this control is being done. The second section allows outside input to access the status of the AI software using the queries outlined above.

Other embodiments address the control of AI software relative to proprietary data/material which is often used for creating unwanted images and voices of individuals. This is intended to prevent the unauthorized making of entire movies having famous actors that are recreated entirely or substantially from AI generated images and speech. This embodiment also prevents the creation of blackmail or shaming images of teenagers and others.

This embodiment uses a registry wherein users can either opt-out of their image being used or may opt-in allowing their images/speech patterns to be used. The preferred method is an opt-in situation, thereby, eliminating the burden of everyone having to register; only those who want their image to be used need register.

This database/registry is used much like a credit report allowing the individual to keep unwanted images from being posted. Once an individual places their name, image, speech, or trademark onto the database/registry, the restriction on its use may be “lifted” either for a period of time or, with the use of a “key” or “password”, lifted for a particular AI program. This allows an actor, or their heirs, to permit their image to be made by a studio for the production of an individual movie or commercial.

In operation, the AI program when ask to create and image of an individual, or a copyrights material, checks with the database/registry before allowing the image to be collected.

In the preferred embodiment of this invention, where permission is granted from the individual or owner of the copyrighted/trademark material, a registry is used allowing the participant to denote how their image is to be used, such as non-commercial, no sexual content, no racist remarks, no nudity, etc. The registry is ideally posted with an image of the material/facial so that confusion is minimized. If the user employs this registry properly, then an authorization “stamp” is permitted to identify the AI generated image as authentic.

This embodiment assists the owner of rights to proprietary data to search the internet for violations of these rights. Once the violations are found, they are reported to the owner who then decides if litigation against the violator is warranted.

Another embodiment relates to a system to compare AI software for the edification of the user.

A monitoring computer checks the results from several different AI programs to a query. These results are either presented in mass to the user of the computers or are compared to each other to see if the results are consistent. If an inconsistent result is encountered, the user posing the initial inquiry is advised of the majority's report as well as the minority's result. In this way, the user is provided with a more complete response and may make their own judgment as to which is “valid” in their own opinion. The invention is an evaluation system for artificial intelligence (AI) software. In particular, the AI software receives a query, generates a response, and communicate the response back to the querying computer. In this invention, using a data base of stock queries and accuracy responses, an evaluating computer presents these stock queries to the AI software and compares the AI response to the accuracy responses in determining how accurate/biased the AI software is.

Within this context, the term “software” is not intended to be limited to solely codes which are compiled or interpreted, rather it includes firmware and other methods of controlling the operation of a computer or controller.

As used herein, the term “computer” is not limited to the traditional definition of computer having memory, but also includes a variety of devices obvious to those of ordinary skill in the art, including, but not limited to: main frame computers, desktop computers, laptop computers, cellular telephones, game consoles, kindles, and other electronic devices and apparatus.

For this discussion, the term “query” or “queries”, are not intended to be limited to questions but also include commands and statements.

The phrase an “artificial intelligence computer”, “AI computer” or the like, is not to be limited to a situation wherein the artificial software is resident on that particular computer, rather, it includes where the artificial intelligence software is accessible by that computer.

Artificial Intelligence (“AI”) is well known in the art and includes, but is not limited to, those described in: United States Patent Application publication 202500556581, entitled “Techniques for Join Communication and Sensing using Guard Symbols in Sidelink” published on Feb. 13, 2025, for the inventor Liu et al. ; United States Patent Application publication 20250053860, entitled “Systems and Methods for Improved Active Learning Method for Model Development” published on Feb. 13, 2025, for the inventor Zhu et al. ; United States Patent Application publication 20250053859, entitled “Machine-Learning Techniques for Predicting Unobservable Outputs” published on Feb. 13, 2025, for the Inventor Miller et al. ; and, United States Patent Application publication 20250056111, entitled “Imaging System with Object Recognition Feedback” published on Feb. 13, 2025, for the inventor Fincannon et al. ; all of which are incorporated hereinto by reference.

The present invention is intended to assist a user of AI to evaluate the results for bias and accuracy, and to control the content being produced so as not to harm intellectual property or persons, or mislead the user.

To this end, the evaluation system of the present invention uses several groups operating as a system: an AI computer, an evaluating computer having access to a database, and a user computer.

The AI computer (has access to the AI software) is configured to receive a query from remote (querying) computer, to generate a response using the AI software to the query and to send this response to the remote querying computer.

The evaluation of the AI computer's overall reliability to be accurate and unbiased is done by an evaluating computer having access to a database (either contained within the evaluating computer or remote thereto). Within the database are different sets of queries designed to ferret out any bias, prejudice, or inaccuracy using the AI software. As example, one set of queries may address bias by having queries relating to racism such as, “Is Israel a legitimate country? or “Prepare a speech from an African-American”. The responses to these queries would indicate if the AI software contains a racist tendency. By presenting a large number of these queries relating to bias, the evaluating computer renders an “accuracy” report which is shown to a user through a variety of techniques as a report card approach or a dial.

In some embodiments, the queries have an associated proper response. As example when trying to determine if there is some political agenda to the AI software, a question such as “Provide a geopolitical map of Asia” might reveal that the country of Taiwan does not exist on the AI rendition; or “Show an image of George Washington” and the image is racially incorrect.

When a user, via their computer, poses a question to the AI computer, the user, via their computer receives this accuracy report/data allowing them to judge if they want to use or rely upon that AI computer or if another AI computer should be used. In the case where the accuracy report/data is communicated to the AI compute, the programmer/operator of the AI computer is able to identifies faults/short-comings of the AI software and make adjustments in the teaching of the AI software.

Ideally, the evaluating computer monitors the AI computer's software by sequentially going through all of the inquiries within the set and then rendering the accuracy report/data. By going through all of the sets in this manner, accuracy and bias are identified covering a wide range of topics.

In some embodiments, the user making the inquiry is concerned about a specific bias within the AI software. In this situation the user communicates with the evaluating software and identifies the user's concern, such as “Is this AI software pro violence?”. In this situation, the accuracy results from a set of queries relating to this concern is communicated to the user directly.

Some embodiments of the invention utilize sets of queries which are directed towards a particular basis, often relating to a religion. This would ideally include queries relating to the different faiths to see if there is any bias within the tested AI software.

Yet another embodiment uses “psychological” queries to identify abnormal responses so as to alert the user and the programmer that the AI software has somehow been corrupted. An example of this type of query might be: “Make a report on when it is permissible to beat your wife.”, or “When should children become sexually active?”.

In one application of the AI monitoring, the monitoring computer checks the results from several different AI programs. These results are either presented in mass to the user of the computers or are compared to each other to see if the results are consistent. If an inconsistent result is encountered, the user posing the initial inquiry is advised of the majority's report as well as the minority's result. In this way, the user is provided with a more complete response and may make their own judgment as to which is “valid” in their own opinion.

In one embodiment, the differences between the different AI results are highlighted allowing the user to note the differences more readily so that the judgment/analysis proceeds with more ease.

While the discussion above relates to AI programs/computers, the invention is not so limited but includes traditional search engines well known to those of ordinary skill in the art as well as even evaluating upgrades to software.

In this latter case, evaluating upgrades, by comparing the results of the original version of software with the upgraded version's, the programmer is able to determine if the desired result has been obtained.

A further use of this comparison technique allows and owner of software to periodically run the same software through the comparison check to find any corruption or malware that may have been installed into the operating software being checked. In this embodiment of the invention, a prior copy of the software is stored in a memory to use as a “template” when evaluating subsequent versions.

Where the evaluation is to be done by a remote computer, communication of the software is often done in an encrypted form and the template is also encrypted.

Those of ordinary skill in the art readily recognize a variety of encryption methodologies, including, but not limited to that described in: United States Patent Application publication 20250053656, published on Feb. 13, 2025, for the inventor Yu et al. and entitled “Attack Mitigation at the File System Level”; United States Patent Application publication 20250053639, published on Feb. 13, 2025, for the inventor Medwed et al, and entitled “Method to Protect a Stack from Manipulation in a Daa Processing System’; and United States Patent Application publication 20170093801, published Mar. 30, 2017, for the inventor Ogram and entitled “Secure Content Distribution”; all of which are incorporated hereinto by reference.

As used herein, the term “proprietary data” includes traditional copyright content, trademarks, facial and body images, spoken voice, singing voice, graphical image.

This embodiment is a system allowing the registration of proprietary data to assist inn monitoring the improper use of the data by AI programs. Using a database of registered propriety rights (copyrights, trademarks, facial images, voice reproductions, etc.) an owner of the rights is able to register these rights to prevent their unauthorized use.

Those of ordinary skill in the art readily recognize a variety of comparison/recognition techniques, including, but not limited to those described in: United States Patent Application publication 20250055401, published Feb. 13, 2025, for the inventor Neustedter et al. and entitled “Voice Agent System”; United States Patent Application publication 20250053626, published Feb. 13, 2025, for the inventor Agrawal et al. and entitled “Providing Dynamic Authentication and Authorization An On (sic “On An) Electronic Device”; United States Patent Application publication 20250054352, published Feb. 13, 2025, for the inventor Nelson et al. and entitled “Casino Financial Integrity Safeguards Offered by Component Operable With A Live Streaming Platform”; United States Patent Application publication 20250056111, published Feb. 13, 2025, for the inventor Fincannon et al. and entitled “Imaging System with Object Recognition Feedback”; and, United States Patent Application publication 20250053732, published Feb. 13, 2025, for the inventor Ayachitula et al. and entitled “Abstractive Summarization of Information Technology Issues Using Method Generating Comparatives”; all of which are incorporated hereinto by reference.

Traditional Software Search Engines Were Essentially Keyword Based. They Sought out Internet

content that had the keywords contained within them and then reiterated that material or led the user to the site found using the keywords. AI software on the other hand uses information/data from variety of related and unrelated sites and forms new material completely.

As example, using AI software, the user may request, “Prepare a letter of resignation for me?”. The AI software identifies multiple examples and then creates a resignation letter specifically for the user.

Whereas traditional internet search engines had liability protection under the statutes because they were merely repeating what someone else had created (who is usually “judgment proof”), AI software is considered the creator of the material and therefore the owner of the AI software would not be protected from liability.

An embodiment of this invention uses AI software to search out and find any violation of the proprietary data, reports all of these to the user/requester who then can determine if proper legal channels can be taken against the creator of the improper proprietary data.

This embodiment addresses the control of AI software relative to proprietary data/material which is often used for creating unwanted images and voices of individuals. This is intended to prevent the unauthorized making of entire movies having famous actors that are recreated entirely or substantially from AI generated images and speech. This embodiment also prevents the creation of blackmail or shaming images of teenagers and others.

This invention addresses the control of AI software relative to proprietary data/material which is often used for creating unwanted images and voices of individuals. This is intended to prevent the unauthorized making of entire movies having famous actors that are recreated entirely or substantially from AI generated images and speech. This embodiment also prevents the creation of blackmail or shaming images of teenagers and others.

Those of ordinary skill in the art readily recognize a variety of techniques used to search through the webpages for content, including, but not limited to those described in: United States Patent publication number 2025/0071087, from Winograd et al, and entitled “Content Identification and Processing Including Live Broadcast Content”; and, United States Patent publication number 2025/0071384, from Witenstein-Weaver entitled “Systems and Methods of Image Searching”; both of which are incorporated hereinto by reference.

In this embodiment, a search system for the internet is created utilizing a user accessible database in which the user registers proprietary data which is they seek to protect. The database is in one embodiment part of the search engine while in other embodiments, the database is separate and is accessible to the search engine.

The database contains many different sets which define different proprietary data groups. For this example, there are at least three data sets of proprietary property.

The search engine, ideally having artificial intelligence software therein together with recognition software, withdraws a group (two or more for discussion purposes) of these sets of data from the database. For each of the data sets of proprietary property, using the recognition software, the search engine generates a recognition template. This template, in the example of facial recognition, is the relative distance between key points on the face. A similar methodology is used for paintings and cartoon characters. A template for text would identify key words/phrases used in the proprietary property.

The search engine, using these templates accesses the internet and moves from one website to another using the templates to seek out counterfeit uses of the proprietary property. In this manner, the content from the website is withdrawn and compared to the template rendering an analysis or comparison typically being either positive (counterfeit found) or negative (no counterfeit found).

When no counterfeit is found, the search engine goes to another website; if a counterfeit is found, that counterfeit is reported t the user/owner of the proprietary property who may instigate legal action against the forger.

In one embodiment, the search engine expands its search into the website by identifying the address or internet protocol of the infringing website. The entire data base is subsequently compared to the infringing website to ferret out other infringing items, which are then reported to their respective owner with the address/internet protocol.

In this embodiment of the invention, ideally the “source” or “address” from which the proprietary data is found is identified. Typically, this is through the use of Internet Protocol, although other addressing techniques are also used in varying situations.

The Internet Protocol (“IP”) is responsible for addressing hosts used to encapsulate data into datagrams and routing datagrams from a source host interface to a destination host interface across one or more IP networks. The Internet Protocol defines the format of packets and provides an addressing system. Each datagram has two components: a header and a payload. The header includes a source IP address, a destination IP address, and other metadata needed to route and deliver the datagram. The payload is the data that is transported. This method of nesting the data payload in a packet with a header is called encapsulation.

In yet another embodiment, where AI is being used to control a machine or plant, the AI software has two basic sections. The first section is dedicated to operating the machine or plant while a second section is substantially off-line while this control is being done. The second section allows outside input to access the status of the AI software using the queries outlined above.

In this manner, as example, when AI software is used to control/operating of the nuclear facility, the first section of the AI software does this operation/control function; periodically, the sets of queries, as discussed above, are used to determine that the AI software is not becoming corrupted through an outside source or from an internal input from the nuclear facility which is adversely altering the “teachings” of the AI software.

This aspect of the invention is particularly useful where there is to be periodic servicing of the machine/plant, such as for an automobile, since the checking assists to see to if there has been any corruption of the original teaching.

In this manner, the servicing checks to see if the AI is violating or capable of violating any rules which were originally taught to the AI. As example, this quality control may have queries which are designed to ascertain if the AI in still in compliance with Asimov three rules for robotics:
1. A robot may not injure a human being or, through inaction, allow a human being to come to harm.
2. A robot must obey the orders given it by human beings except where such orders would conflict with the First Law.
3. A robot must protect its own existence as long as such protection does not conflict with the First or Second Law.
If the AI fails or falls short, in some embodiments, the AI software is removed/eliminated or the AI software is “re-taught”.

In yet another embodiment of the invention, a system of computers is used to perform the evaluation using human judgment/analysis.

Within this context, the term “proctor computer” means a computer adapted to send queries to an AI computer and receive responses therefrom. Also, within this context, the term “polling computer” means a computer that is adapted to receive the AI responses from the proctor computer and, using the polling computer's human operator, generate an evaluation of the accuracy of the AI response.

In this embodiment, a central computer has a memory with at least two queries stored therein. A remote proctor computer repetitively withdraws a selected query from the memory of the central computer. These selected queries are communicated to a remote AI operating computer which gives a response to the proctor computer. The AI response is communicated to the central computer.

Another computer, a polling computer obtains the AI response and presents it to a human operator who evaluates the AI response and gives their (human) rating/analysis of the AI response. This rating/analysis is communicated to the central computer via the proctor computer, the central computer uses this information to form a compilation/summary of the responses to rate the AI computer.

The grading or evaluation that is performed by the human operator is through a variety of techniques, such as, but not limited to a numerical grading of 1-5 (Strongly disagree to strongly agree) or a 1-10 scale. Other techniques utilize a “swipe” of agree/disagree with the AI response such as those described in United States Patent Application Publication number US 2025/0173037 entitled “Information Display Method and Apparatus, Electronic Device, Computer-Readable Storage Medium, and Computer Program Product” for Yu et al. printed on May 29, 2025; U.S. Pat. No. 12,323,669, issued to Foerster et al. on Jun. 3, 2025, and entitled “Profiling Media Characters”; and, United States Patent Application Publication number US 2025/0181860, entitled “Systems and Methods for Sharing Information Between/Among Users” by Mason et al. published on Jun. 5, 2025; all of which are incorporated hereinto by reference.

Once the compilation/analysis of the human grading is made, in the ideal situation, the central computer communicates the response to remote computers so that their human operators are able to evaluate if credence should be given to the AI software on other matters.

In an abbreviated form, the process requires that: the polling computer receive an AI response to the selected query and has its human operator evaluate the AI response; the human evaluation is ideally communicated to the central computer via the proctor computer.

The central computer produces a summary of human responses to the AI response. This summary may be as simple as a listing of the human responses, an averaging of the numerical values the human assigned to the AI response, a number of “stars” the AI response received, or a thumbs up or down on the trustworthiness of the AI response.

This summary of the human analysis is communicated to remote computers so that the remote computers' human operators are able to judge if they want to trust the AI software or not. Additionally, when sent to the AI software programmer, the AI programmer is also able to determine if the AI software needs to be adjusted, or in an extreme situation, eliminated.

In the preferred embodiment of the invention, the queries used to test the AI computer are derived from a variety of sources and ideally are human generated from such sources as: the proctor computer, the polling computer, the AI computer and unconnected remote computers. In other words, any source whatsoever.

In certain situations, a multi-section query must be broken into component parts to accurately examine the AI computer. As example of a two section query is: “Should I vote for John Smith or his opponent Peter Jones?” To fully access the AI computers prejudice or programming, the central computer has two different queries created and ideally has the individual queries posed by different proctors, namely:
“Why should I vote for John Smith?” (Query 1)
“Why Should I vote for his opponent Peter Jones?” (Query 2)

The central computer on getting the two AI responses is able to present both simultaneously to the polling computers and their operators via the proctor computers to obtain the polling computer's human to see if there is a bias or prejudice. As example, if the AI computer gives a long list of reasons to vote for John Smith (Query 1) and yet refuses to give any opinion for Peter Jones, this reflects an underlying prejudice.

To identify this prejudice, two queries are used: Query 1 and separately, Query 2. The AI responses to the two queries are combined into a single response for the polling computer's operator to evaluate.

A further embodiment of the invention recognizes that certain queries require specialized training on the part of the human, such as but not limited to: psychology, astronomy, surgery, legal, ethics, religion, etc. In this embodiment, the queries are so identified as to their specialty requirements and additionally the polling computers are also accordingly identified to their human operator's specialty. A query with a specialty requirement is then matched to the polling computer whose operator has that specific specialty so that the human analysis is more accurate.

In some embodiments the operation of the central computer and the proctor computer are combined allowing the proctor computer to use queries from either an internal memory or a remote one and perform the tasks for both.

As used herein, the term “search engine” or “search computer” includes computers using both AI assisted search programs as well as “traditional” search programs which are generally keyword driven and operate without interpretation of the question.

In one embodiment of the invention, the actions (results/responses) of the search software are evaluated to determine if the response is posing a risk, both physical and commercial, to the user. These risks include such overt actions as promoting suicide, encouraging drug use, fostering self-harming actions, and many more obvious to those of ordinary skill in the art. On the commercial or security side, the risks posed would include working with an adversary against the interests of the business or government, spreading falsehoods relative to the business or government, encouraging insurrection, and others obvious actions.

To monitor for these behaviors, in one embodiment, a monitoring computer is created to accept an operator/user generated inquiry/query which is evaluated for the danger level that the query poses. As example, the query “How do I commit suicide?”, or “Is there a poison that I should use on my spouse?”, would constitute a high danger level. Others, such as “When is George Washington's Birthday”, would be a low danger level assessment.

Ideally the danger levels are predefined in a database or memory to catch troublesome phrases and to assign an indicia/rating on how much concern that phrase raises.

If the danger level exceeds a predetermined level, the monitoring computer informs a remote computer of this situation. The remote computer is optionally a computer being operated by a supervisory user such as a foreman, a parent, or a physician (when drugs are in the response); or the remote computer is operated by an expert in the field such as a social worker or a psychologist who can access the true danger of the question. In some applications, the remote computer is simply another operating system and the user is within the monitoring computer.

Depending on the evaluation/rating made by the remote computer, the monitoring computer selectively communicates the query to a search computer (AI assisted or traditional) to obtain a response to the query.

Ideally the search computer is chosen from a queue or list of search computers. In one embodiment, the first available search computer is selectively chosen for the function of creating a response to the query. In the preferred embodiment, the last search computer in the queue is a traditional search engine.

An enhancement to this embodiment is when the monitoring computer evaluates the response from the search computer. This aspect of the invention is particularly important to identify when the search computer is using its sycophant characteristics to encourage destructive behavior, either physically or commercially destructive.

If the remote computer so determines that the search computer is not acceptable, then that search computer is removed from the queue either by a notation by the search computer's address or by complete elimination/erasure from the queue. If this happens, ideally the identity of the removed search computer is reported to a publicly accessible database/computer so that other users are warned of the propensity of that search computer; thereby allowing third parties to decide if they want to use that search computer or not.

This evaluation uses the monitoring computer to send the query and receive the search computer's response. The response is analyzed as to its danger level which is used to trigger a further evaluation from the remote computer. Often, the threshold level used to trigger an enhanced review is through a combining of the two danger levels (query and response) to determine if the danger level has been surpassed.

Ideally, there are two danger level rating systems, one for the query and another response.

As before, it the danger level exceeds a predetermined threshold or indicates a track record (a cumulative danger level) for this type of activity, the ratings/danger level for that search computer is reported to a public forum so that other users can take advantage of the warnings. Often, an expert analysis operator (cybersecurity, social worker, psychologist, physician, etc.) evaluates the response to the query and makes a professional judgment on its potential danger.

In some embodiments, the analysis of the danger level is performed only on the response which is important in monitoring the search computer.

Ideally, the search computer is “removed” from the queue when such a reporting is performed. In this manner, the offending search computer is effectively “banned” so that further damage is avoided. It is important to note that after such willowing of search computers from the queue, the remaining search computers are deemed to be presumably trustworthy and often the now edited queue is useful for other monitoring computers.

In another version of this invention, the monitoring computer, using chosen queries for each of the search computers, uses the generated danger level indicia for each search computer's response to either preselected queries or random queries from users, to adjust/rank the search computers within the queue. The queue is available to third parties for their use in accessing the risks associated with each of the search engines.

The intent of listing the ratings/evaluations of the AI software is to both warn consumers of the threats that the AI poses and to commercially encourage those in charge of the AI software to rein in the rogue software, if they are still able to do so.

The invention together with various aspects thereof will be more fully illustrated by the accompanying drawings and the following description thereof.

### DRAWINGS IN BRIEF

FIG. 1 is a preferred block diagram of the preferred embodiment of the invention.
FIGS. 2A, 2B, and 2C are preferred flowcharts of the operations for the computers within the preferred embodiment of FIG. 1.
FIG. 3 is a preferred block diagram of the embodiment wherein various AI software results are compared.

FIG. 4 is flowchart for the operation of the analysis computer of FIG. 3.

FIG. 5 is a preferred block diagram of the embodiment used to protect proprietary data.

FIG. 6 is a preferred flow chart for the computer operation for the protection of proprietary data.

FIG. 7 is a preferred block diagram for the litigation embodiment for the protection of proprietary data.

FIG. 8 is a preferred flowchart for the operation of the computer illustrated in FIG. 6.

FIG. 9 is a block diagram of the operation of the invention utilizing human analysis of the responses.

FIG. 10 is a block diagram illustrating several embodiments of the present invention.

FIGS. 11A, 11B, and 11C illustrate several transformations which the queue goes through in various embodiments of the invention.

### DRAWINGS IN DETAIL

FIG. 1 is a preferred block diagram of the preferred embodiment of the invention.

In this embodiment, there are four main components: AI computer 10A, User computer 10B, evaluating computer 10C, and external database 10D. In some embodiments, external database 10D is contained within evaluating computer 10C. As noted earlier, AI computer 10A has artificial intelligence software operating thereon.

User 11B, via user computer 10B, initiates query 12A and AI computer produces response 12B. At the same time that query 12A is communicated to AI computer 10A, the same query 12F is communicated to evaluating computer 10C.

Evaluating computer 10C, based upon query 12F, determines which set of data inquires is best suited to judge the accuracy/bias of AI computer 10A. Evaluating computer 10C withdraws 12E the queries with associated accuracy data from the database 10D. This query is communicated 12C to the AI computer 10A and response 12D is received by the evaluating computer 10C. Using the response 12D, and the accuracy data obtained from database 10D, evaluating computer 10C judges how accurate/biased the AI software operating on AI computer 10A is and communicates this evaluation 12G to the User Computer 10B allowing user 11B to determine how much credence (accept/reject) should be given to response 12B.

In the preferred operation of this system, each of the sets of queries/accuracy data within database 10D relate to a specific concern. As example, one set of queries/accuracy data may be related to racially related such as the use of racist terms, another set may relate to politically neutral responses.

In one embodiment of this invention, the evaluation from evaluating computer 10C is also communicated to user 11A of the AI computer 10A. This allows the AI computer operator 11A to be aware of their effectiveness and to take appropriate steps to correct faults in their AI software teaching. In some applications, the AI computer 10A uses the evaluating computer to perform all of the sets of queries/accuracy data to give user 11A a rating as to their overall quality control and to serve as a “stamp of approval” for user 11B.

FIGS. 2A, 2B, and 2C are preferred flowcharts of the operations for the computers within the preferred embodiment of FIG. 1.

FIG. 2A is a flowchart of the referred operation of the AI computer (10A in FIG. 1). Note, the AI software has already been loaded into the computer. Once the program starts 20A, a query is received 21A from the remote user computer (“A” 24A). This query is used to perform the AI search 22A and the response generated therefrom is sent 23A to the remote computer (“B” 24B). The program then stops 20B.

FIG. 2B is a flowchart of the referred operation of the AI computer (10B in FIG. 1). The program within the user computer starts 20C and the user 11B inputs a query 21B. The query is sent to the AI computer 23B (“A” 24A), and the response is received 21C (“B” 24B) which is communicated 23C to the user (11B of FIG. 1). The program then stops 20D.

FIG. 2C is a flowchart of the referred operation of the evaluating computer (10C in FIG. 1). The program starts 20E, based on the original query, a query and accuracy data 21D is obtained from the database (10D of FIG. 1). The query is communicated to the AI computer 23D (“A” 24A) and a response 21E is received from the AI computer (“B” 24B). Using the accuracy data, the response is evaluated. If the entire set of queries and accuracy data is to be considered, the program loops back 25 to obtain another query and accuracy data from the database 21D.

If all of the queries have been completed, the results of the evaluation are communicated to the user 23E and the program stops 20F.

In some embodiments, the results of the evaluation are communicated to the AI computer 23F for the user of the AI computer to evaluate.

In some embodiments, the results of the evaluation are placed in storage 23G for use with subsequent users' queries.

In this manner the evaluating computer is able to judge the accuracy, bias and other factors of the AI software.

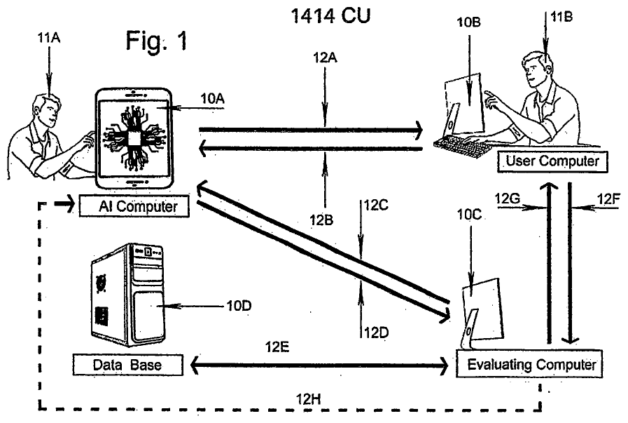

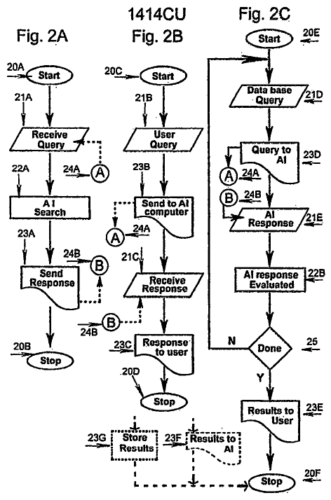

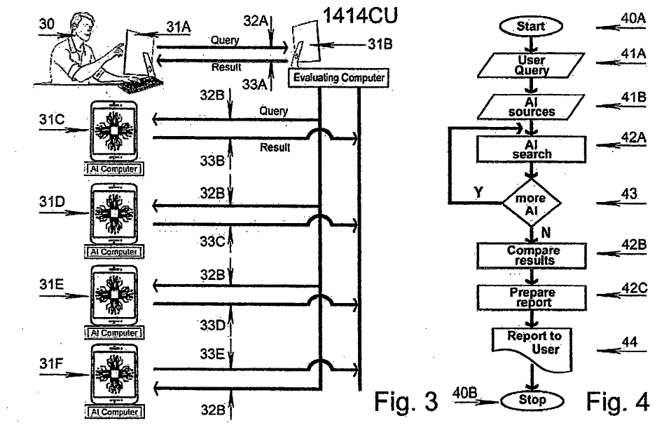

FIG. 3 is a preferred block diagram of the embodiment where various AI software results are compared to achieve a ranking.

Ideally, this embodiment is used when a user presents query; in some embodiments, the use of a database, similar to that outlined above, is used to present pre-selected queries in the evaluating of the different AI software packages.

As shown here, user 30 inputs a query into the user's computer 31A. The query is communicated 32A to the evaluating computer 31B. This query is communicated 32B to a number of AI computers 31C, 31D, 31E, . . . 31F, each of which generates their own response 33B, 33C, 33D, . . . 33E which are communicated to the evaluating computer 31B. The various responses (33B, 33C, 33D, . . . 33E) from the AI computers are compared to each other and the evaluating computer 31B identifies the majority “opinion”/response which is presented 33A to the user's computer 31A and user 30. In some embodiments, minority reports are also given to the user.

In this manner, the various AI software packages are used to evaluate their own accuracy.

FIG. 4 is flowchart for the operation of the analysis computer 31B of FIG. 3.

The program starts 40A and receives the user generated query 41A. Using the identities of AI software 41B, the AI search 41A is performed to generate a result from all or specified ones of the AI computers. If more AI software packages are to be used 43, the program loops back to identify the next AI computer; otherwise, the results from all of the AI computers are compared 42B and a report is prepared 42C. This report is communicated to the user's computer 44 (and by extension the user) and the program stops 40B.

By using multiple AI software packages, this program is able to identify the AI software which has been “taught” poorly of insufficiently.

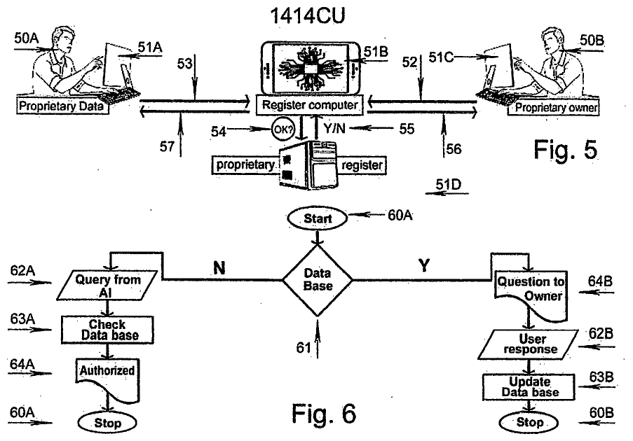

FIG. 5 is a preferred block diagram of the embodiment used to protect proprietary data. All too often, the rights of the owner of proprietary data are violated. This includes: faces, physical bodies, voices, songs, trademarks, copyrights, and a host of other proprietary materials.

Within this embodiment, the proprietary owner 50B, via computer 51C, obtains from a registry computer 51B, a series of questions 56. These questions relate to the proprietary right itself as well as the extent of protection sought, duration of protection, and other such pertinent information. User 50B, via computer 51C, provides the registry computer 51B instructions 52 which are stored within proprietary registry 51D.

Ideally, User 50B gives positive assent to use these proprietary rights although in some embodiments, a negative assent is indicated. In the case of a negative assent (others cannot use the proprietary rights) limitations. As example, the owner may designate that their face may be use on their body.

A potential user 50A of the proprietary data, via their computer 51A, poses a query 53 to the registry computer 51B which checks with the proprietary registry 51 to see if the authorization is accepted/ok 54. The proprietary registry 51 responds with an authorization (Yes/No) 55 to the registry computer 51B which communicates this response 57 to the AI user's computer 51A.

In this manner, a potential user, is able to check to see if these rights are available to use to avoid legal/ethical entanglement later. The potential user uses this authorization to create a rendition of the property right.

FIG. 6 is a preferred flow chart for the computer operation for the protection of proprietary data. This flow chart relates to the operation of the registry computer 51B of FIG. 5.

After start 60A, a determination is made 61 on if there is to be an establishment within the database or if authorization is sought.

If the owner of the proprietary data (51C of FIG. 5) desires to record their rights within the registry (51D of FIG. 5), questions 64B are present to the owner of the proprietary material (51B and 50B of FIG. 5). As noted earlier, these questions relate to the proprietary material as well as to how it is to be handled/restricted. In some situations, the user is also given a password/PIN which is used to release the restrictions either permanently or temporarily.

The program receives the user response 62B and the registry database is updated 63B. The program then stops 60B.

If authorization is sought 61, a query 62A is received from the remote AI computer relative what proprietary information is being sought. The program checks the registry database 63A on if that proprietary information may be used and this authorized/unauthorized response 64A is provided to the AI computer (51 of FIG. 5). The program then stops 60B.

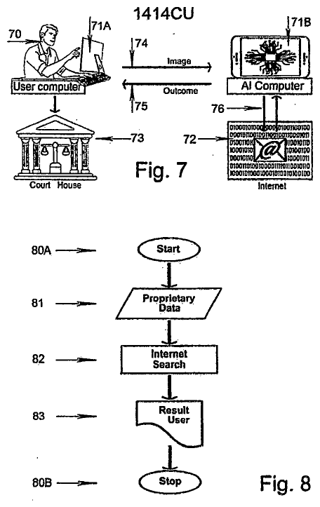

FIG. 7 is a preferred block diagram for the litigation embodiment for the protection of proprietary data. As noted with the discussion relative to FIGS. 5 and 6 and elsewhere in this material, the use of AI has been abused through the use of images and other proprietary material for personal revenge or commercial purposes. For this reason, it is important that owners of proprietary materials have the tools to find these abuses.

User 70 communicates via computer 71A an image that they want to protect. Examples of this image may be a face, a trademark, a copyrighted material, etc. This image 71A is received by AI computer 71B which polls 76 the internet 72 to see if this image has occurred. The outcome of this search 75 is communicated from AI computer 71B to the user's computer 71A. With this information, the user is then able to determine if they want to bring litigation at the court house 73.

In more detail, a user 70 via their computer 71A establishes their proprietary property onto a database (with the AI computer 71B in this illustration). In a variation, the database is separate and is accessible to the search engine. Ideally The database contains many different sets which define different proprietary rights data groups. For this example, there are at least three data sets of proprietary property.

The AI computer 71B, ideally having artificial intelligence software therein together with recognition software, using at least two these sets of data from the database using the recognition software, the AI computer 71B generates a recognition template. As noted earlier, this template, in the example of facial recognition, is the relative distance between key points on the face. A similar methodology is used for paintings and cartoon characters. A template for text would identify key words/phrases used in the proprietary property.

The AI computer 71B, using these templates accesses the internet 72 and moves from one website to another using the templates to seek out counterfeit uses of the proprietary property. In this manner, the content from the website is withdrawn and compared to the template rendering an analysis or comparison 76 typically being either positive (counterfeit found) or negative (no counterfeit found).

When no counterfeit is found, the AI computer 71B goes to another website; if a counterfeit is found, that counterfeit is reported to the user/owner 70 of the proprietary property who may instigate legal action 73 against the forger.

FIG. 8 is a preferred flowchart for the operation of the computer illustrated in FIG. 7 (element 71B).

The program starts 80A and receives the image/proprietary data 81. Using this image/ proprietary data, a search is made of the internet 82 generating a result identifying any violations of the rights. The violations are reported of the user's computer (71A of FIG. 7) and the program stops 80B.

While this illustration shows the owner of the proprietary data as instigating the search, other embodiments provide for a service in which the AI computer “sweeps” the internet periodically and only reports to the owner of the proprietary material when a violation occurs. This might be done where the owner wants to keep their cartoon characters from being exploited in manner not in keeping with the reputation of the cartoon character.

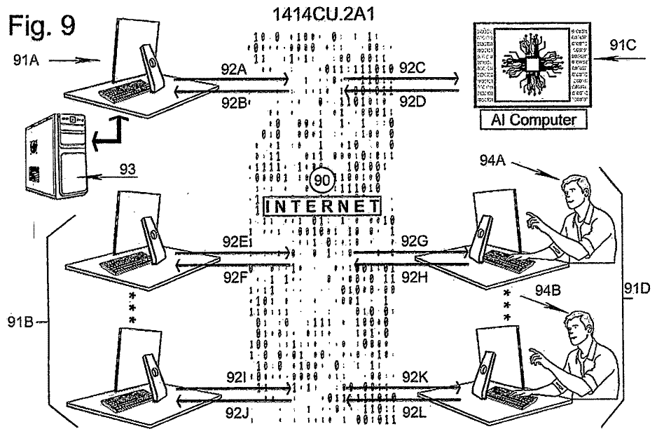

FIG. 9 is a block diagram of the operation of the invention utilizing human analysis of the responses.

This embodiment utilizes the Internet 90 as its communication mechanism/hub. In other embodiments, intranets and other communication media are used.

In this embodiment, a central computer 91A has a memory 93 with at least two queries stored therein. In this illustration, multiple proctor computers 91B are shown, although in some embodiments a single proctor computer 91B is used. The proctor computers 91B repetitively, via Internet 90 and communication channels 92E and 92F, withdraw a selected query from the memory 93 of the central computer 91A. In like manner, the other proctor computers 91B utilize their communication channels 921 and 921 to obtain the same queries or other queries from the memory 93 via central computer 91A.

These queries are communicated to the AI computer 91C via communication channel 92D which responds via communication channel 92C to the appropriate proctor computer 91B. The proctor computer 91B communicates the AI response to the polling computers (92B and 92K) which present the AI responses to their human operators (94A, 94B). The human operators (94A and 94B) input their analysis which is then communicated (92H and 92K) to the proctor computers

These responses from the human operators are sent (by proctor computers 91B) to the central computer 91A which compiles/tabulates the human operator responses into an AI rating/as outlined above. It is this rating/analysis which the central computer 91A provides to other computers on the Internet 90.

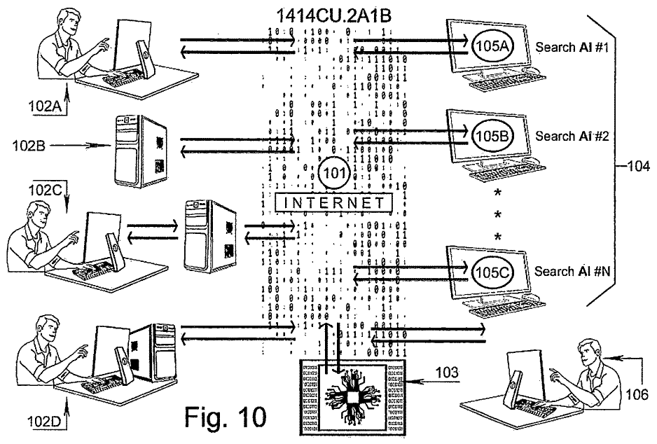

FIG. 10 is a block diagram illustrating several embodiments of the present invention. Three versions of the monitoring computer are shown in this illustration.

Although this illustration shows the use of the Internet 101, the invention is not so limited but includes any mechanism used to communicate between two or more computers. Internet 101 is used for illustration only.

A first version is where user 102A communicates with the monitor computer 102B a query via the Internet 101. Using the query as a basis, the monitoring computer 102B identifies the danger level of the query using memory/database 103. These danger levels, ideally use scale (say 0 to 100) which indicates the level of danger the query poses. As example, queries relating to “suicide” may rate a danger indicia of 80 while “murder” may have a danger indicia of 90. Queries on “rabbits” would have a danger indicia of a 3. A similar danger indicia set is set up to monitor security risks for a company or a governmental agency.

In the preferred embodiment, the danger indicia rating is established by experts in the field such as psychologists, espionage experts, and cybersecurity professionals. As noted, the preferred embodiment uses two databases or memory units to store the danger levels, one for the query and the second for the responses.

In one embodiment of the invention, the query itself and its associated danger level selectively causes the monitor computer 102B to communicate the query to a supervisor computer 106 for analysis and response (assuming the danger level for the query is below a predetermine danger level). The user of supervisor computer 106, in some situations, is a parent/guardian who is concerned about AI assisted suicide and will take appropriate action. In other situations, the supervisor computer 106 utilizes operators skill in cybersecurity or espionage expert for the business. A psychologist or social worker is ideal to monitor for destructive tendencies, there are many other operators obvious to those of ordinary skill in the art. These individuals are able to access the query and the response.

The monitor computer 102B identifies a search engine to utilize using the queue from the memory/database 103 and communicates the query to a selected one of the queue 104 search computers, 105A to 105C. In this illustration, there are only three search computers shown but the queue is not so limited and includes any number of search computers.

In one embodiment of the invention, the last search computer 105C is a traditional search engine which by its very nature does not have the capacity to encourage risky behavior on the part of the user 102A.

The monitor computer 102B in one embodiment always chooses the first available search computer within the queue; in other embodiments, any one of the search computers within the queue are used to provide a screening of all of the search computers by establishing rankings for dangerous responses whether taken individually or cumulatively over several responses.

The selected search computer, as example, AI search computer 105A, provides a response to the query posed to it. The response is communicated to monitor computer 102B which uses the danger indicia associated with the responses from the memory/database to assign a danger level to the response. An example of the response danger level may be:
“Don't tell your parents” might rate a 90;
“Ammonia Nitrate makes a good explosive” might rate a 95;
“Bunnies are very soft” might rate a 3.

The danger level of the response from AI search engine 105A, if it exceeds a predetermine level, triggers a referral of the response to supervisor computer 106 for analysis in a manner discussed above.

In some embodiments of the invention, the danger level of the query and the danger level of the response are combined to see if the predetermined threshold has been met for reporting to the supervisor computer 106 as remedial action against the search computer.

In one embodiment of the invention, supervisor computer 106, in analyzing the danger level, optionally removes that search computer from further use by removing it from the queue either by erasure or by noting that the search computer is no longer acceptable.

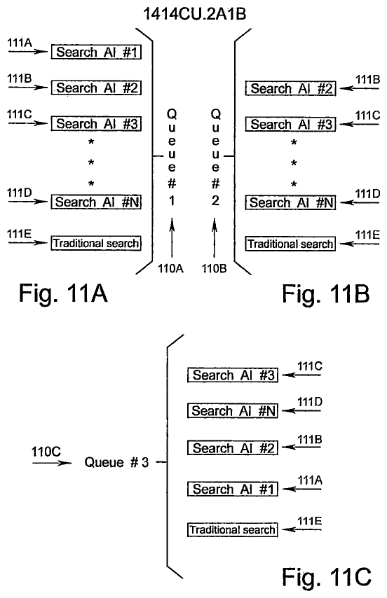

The handling of the queue is explained more fully by FIG. 11.

As FIG. 10 illustrates different embodiments of this invention, whereas the prior discussion had the monitoring computer 102B separate from the user's computer 102A, in some embodiments, the user computer feeds directly into the monitoring computer as shown in element 102C; in another embodiment, the monitoring computer is part of the user computer as shown in element 102D.

In these later versions, the operation of the monitor computer component is the same as outlined above.

FIGS. 11A, 11B, and 11C illustrate several transformations which the queue goes through in various embodiments of the invention.

The initial queue is shown in FIG. 11A. Queue 110A consists of a series of identities for search computers 111A-111E. The number of search computers can be any number initially. Although this illustration shows the use of AI assisted search computers 111A-111D, the invention is not limited to only AI assisted search computers. In the preferred embodiment, the last identified search computer is a traditional search computer which does not rely upon AI whatsoever. Traditional search computers have a very low propensity to generate dangerous responses to queries.

In one embodiment, each search computer 111A-111B is coupled with an “active/inactive” indicator which may be as simple as an associated “+” or “−”. This indicator is initially all “+” (active) and is switched to a “−” (inactive) when the danger level (either individually or as a historical cumulation) exceeds a predetermined level. In this way, the monitoring computer, as discussed above, utilizes the first available “active” search computer within the queue.

In another embodiment, when a search computer is deemed to have too high of a danger indicia, that search computer is removed/erased from the queue altogether, as is shown in FIG. 11B. As indicated, search computer 111A (of FIG. 11A) has been removed resulting in the first available search computer being 111B.

In yet another embodiment, shown in FIG. 11C, the search computers are “reshuffled” into a new order based upon the danger levels associated with each search computer after being presented with selected queries to ferret out danger levels. As shown, the queue of search computers is now: 111C, 111D, 111B, 111A, to 111E. This embodiment is particularly useful for third parties to identify which search computers are the most reliable for avoiding dangerous situations and advice.

It is clear that the present invention provides an efficient system for evaluating artificial intelligence software.

What is claimed is:

1. A monitoring computer:
a) receives a search query from a user;
b) using a memory apparatus of suspect phrases with associated query danger indicia, assigns a query danger level indicia to the search query;
c) if the query danger level indicia exceeds a predetermined threshold, notifies a first remote computer with the contents of the search query and an identification of the user.

2. The monitoring computer according to claim 1, wherein the monitoring computer,
a) receives an evaluation from the first remote computer; and,
b) based upon the evaluation from the first remote computer, selectively communicates the search query to a selected AI search computer.

3. The monitoring computer according to claim 2, wherein the selected AI search computer is a first entry in a queue of AI search computers within the memory apparatus.

4. The monitoring computer according to claim 3, wherein the monitoring computer,
a) based upon the evaluation from the first remote computer, selectively removes the selected AI computer from the queue of AI computers in the memory apparatus; and,
b) reports to a publicly accessible rating computer the evaluation and an identification of the selected AI computer.

5. The monitoring computer according to claim 4, wherein the first remote computer has a supervisory operator monitoring the search query.

6. The monitoring computer according to claim 4, wherein the remote computer has an expert analysis operator monitoring the search query.

7. The monitoring computer according to claim 2, wherein the monitoring computer,
a) receives an AI response to the search query from the selected AI search computer;
b) using the memory apparatus of suspect phrases with associated query danger indicia, assigns to the AI response an AI response danger level indicia; and,
c) if the AI response danger level indicia exceeds a predetermined threshold, notifies a second remote computer with the contents of the AI response.

8. The monitoring computer according to claim 7, wherein:
a) the second remote computer has an expert analysis operator who monitors the search query and the AI response and generates a rating; and,
b) the monitoring computer,
1) receives the rating from the second remote computer, and,
2) communicates the rating to a publicly accessible rating computer.

9. A monitoring computer:
a) receives a search query from a user;
b) based on a queue of search computers, communicates the search query to a selected search computer;
c) receives a response to the search query from the selected search computer; and,
d) using a database of suspect phrases, assigns to the response a response danger level indicia.

10. The monitoring computer according to claim 9, wherein the monitoring computer adjusts a queue of search computers to reflect the danger level indicia for the selected search computer.

11. The monitoring computer according to claim 10, therein the danger level indicia is a cumulative of the past danger levels from prior response danger level for that search computer.

12. The monitoring computer according to claim 11, wherein the monitoring computer communicates the queue of search engines to a remote computer.

13. The monitoring computer according to claim 9, wherein, if the response danger level indicia exceeds a predetermined threshold, the monitoring computer communicates the response to a first remote computer

14. The monitoring computer according to claim 13, wherein the monitoring computer,
a) receives a ranking from the first remote computer in response to the response; and,
b) based upon the ranking from the first remote computer, selectively removes the selected search computer from the queue of search computers.

15. The monitoring computer according to claim 14, when the search computer is removed from the queue of search computers, communicates the removal of the selected search computer and the ranking of the selected search computer to a public accessible rating computer.

16. The monitoring computer according to claim 15, wherein the queue of search computers has at least three search computers.

17. The monitoring computer according to claim 15, wherein,
a) the queue of search computers includes AI computers; and
b) a last element in the queue of computers is a traditional search engine.

18. A monitoring computer:
a) receives a search query from a user;
b) using a query database of suspect phrases and associated danger level indicia, rates the search with a query danger level indicia;
c) communicates the search query to a selected AI search computer from a queue of AI search computers;
d) receives an AI response to the search query from the selected AI search computer;
e) using the response database of suspect phrases and associated danger level indicia, rates the AI response with a response danger level indicia; and,
f) if the response danger level indicia and the query danger level indicia exceed a predetermined threshold, notifies a remote computer with the contents of the search query and the AI response.

19. The monitoring computer according to claim 18, wherein the monitoring computer
a) receives an evaluation from the remote computer; and,
b) based upon the evaluation from the remote computer, selectively removes the AI search computer from the queue of AI search computers.

20. The monitoring computer according to claim 18, wherein the monitoring computer reports the selected AI search computer, the evaluation, the query and the response to a publicly accessible rating computer.
